(19) United States
(12) Patent Application Publication
(10) Pub. No.: US 2014/0350951 A1
(43) Pub. Date: Nov. 27, 2014

(54) METHOD FOR INFUSION THERAPY MANAGEMENT AND MOBILE DEVICE READABLE RECORDING MEDIUM FOR EXECUTING APPLICATION RECORDED THE METHOD

(71) Applicants: Doo Yong Lee, Daejeon (KR); HANVIT MD CO., LTD., Daejeon (KR)

(72) Inventor: Doo Yong LEE, Daejeon (KR)

(73) Assignees: HANVIT MD CO., LTD., Daejeon (KR); Doo Yong Lee, Daejeon (KR)

(21) Appl. No.: 13/903,948

(22) Filed: May 28, 2013

(30) Foreign Application Priority Data
May 21, 2013 (KR) 10-2013-0057354

(51) Int. Cl. G06F 19/00

(52) U.S. Cl. CPC G06F 19/3468
USPC 705/2

(57) ABSTRACT

Disclosed is a method for infusion therapy management and recording medium which records the method in mobile device readable application, which controls fluid flow rate of the fluid set with acoustic output on a cycle of dropping rate corresponding to condition for injection of drug to be mixed in the fluid by inputting the condition as prescription for infusion therapy, registers management items by the patient, manages many patients under infusion therapy using one mobile device with knowledge of the present condition of infusion and infusion ending point, and controls the entire process of fluid infusion by modifying the condition of fluid infusion during the infusion

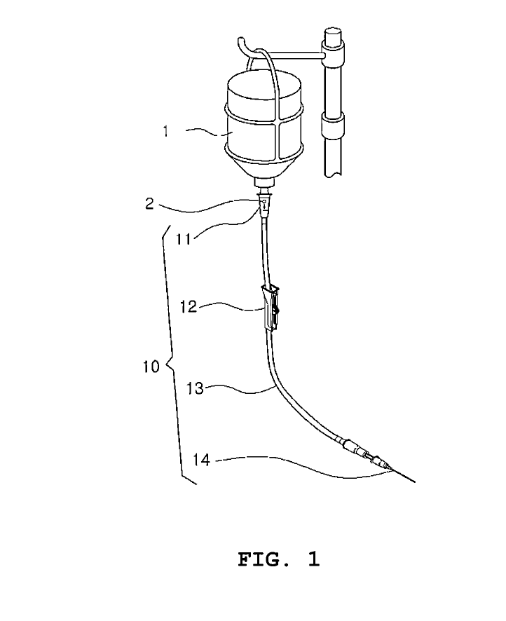

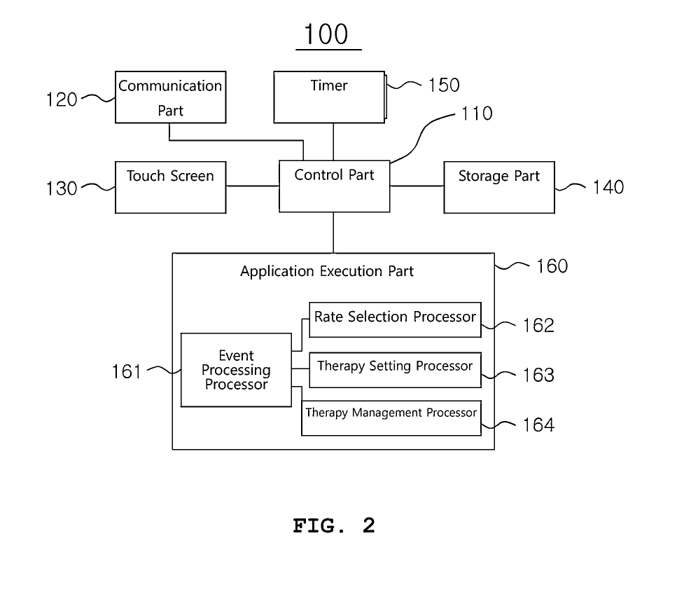

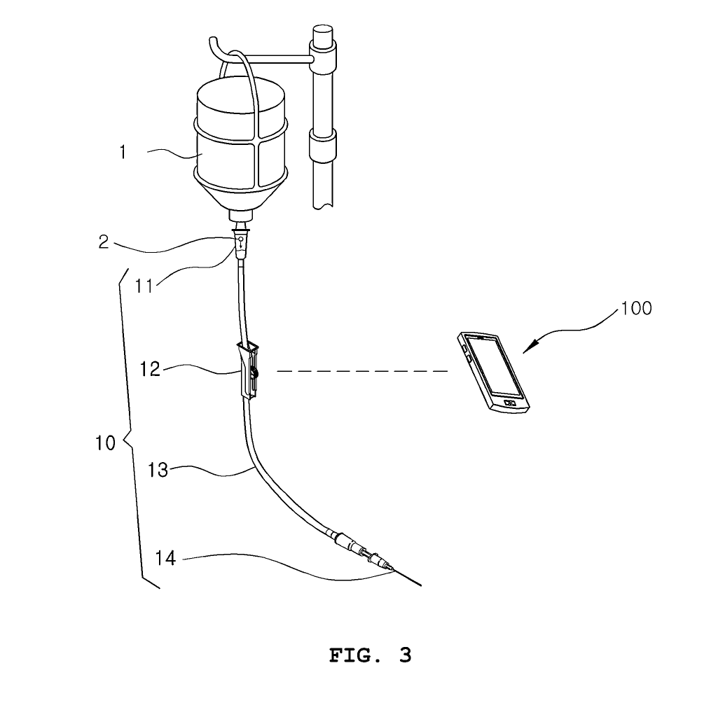

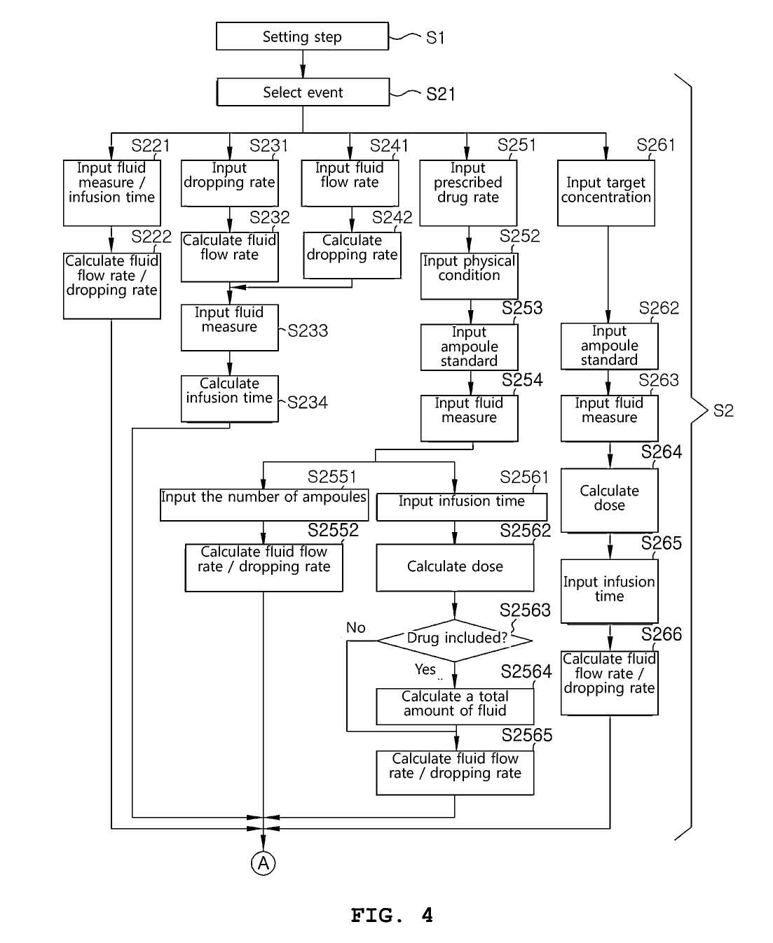

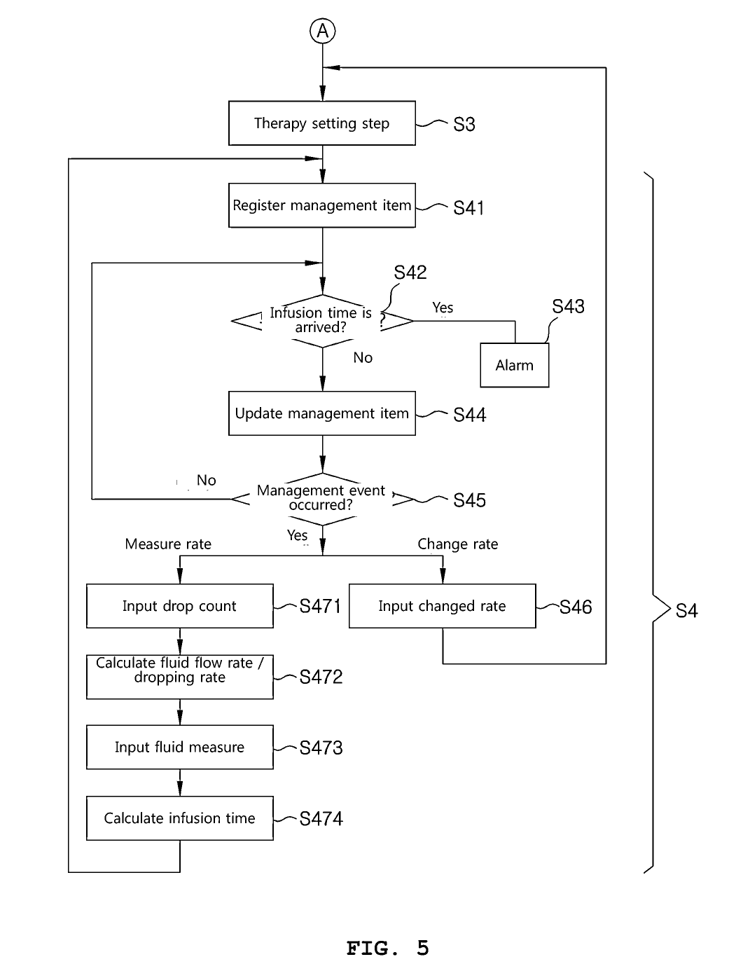

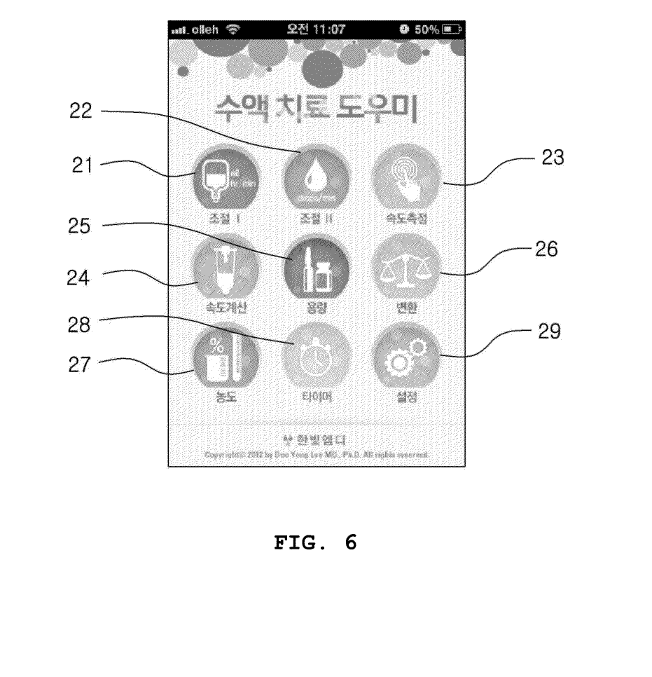

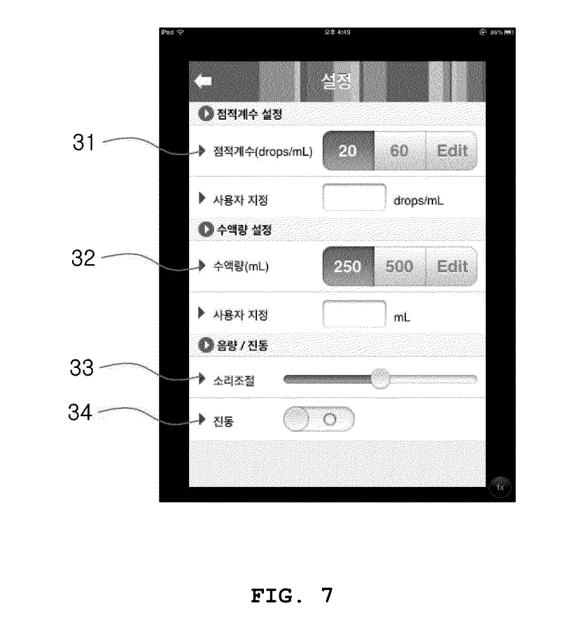

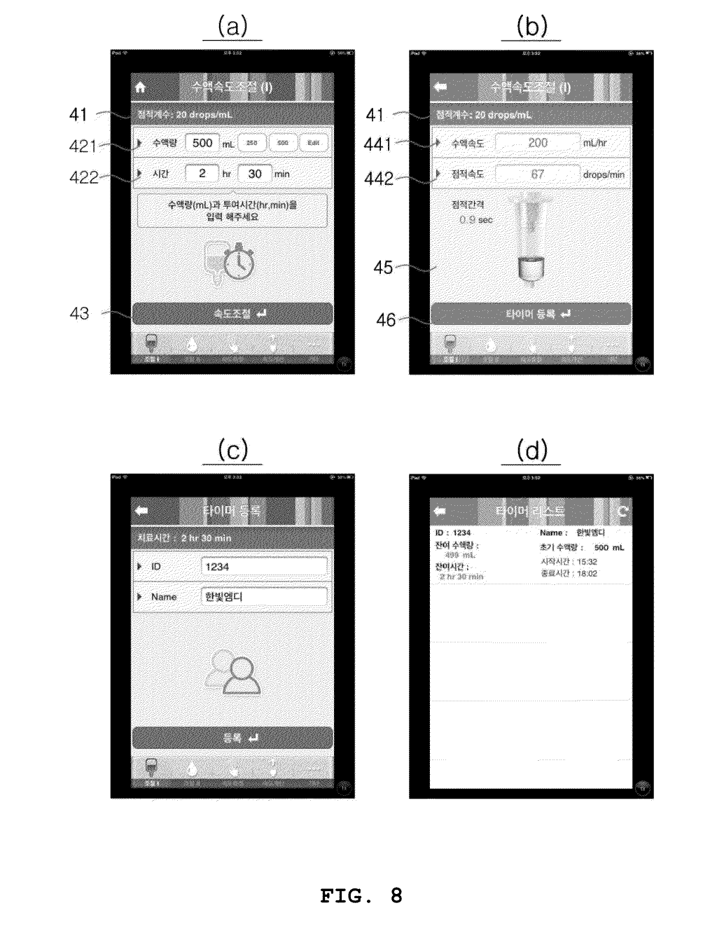

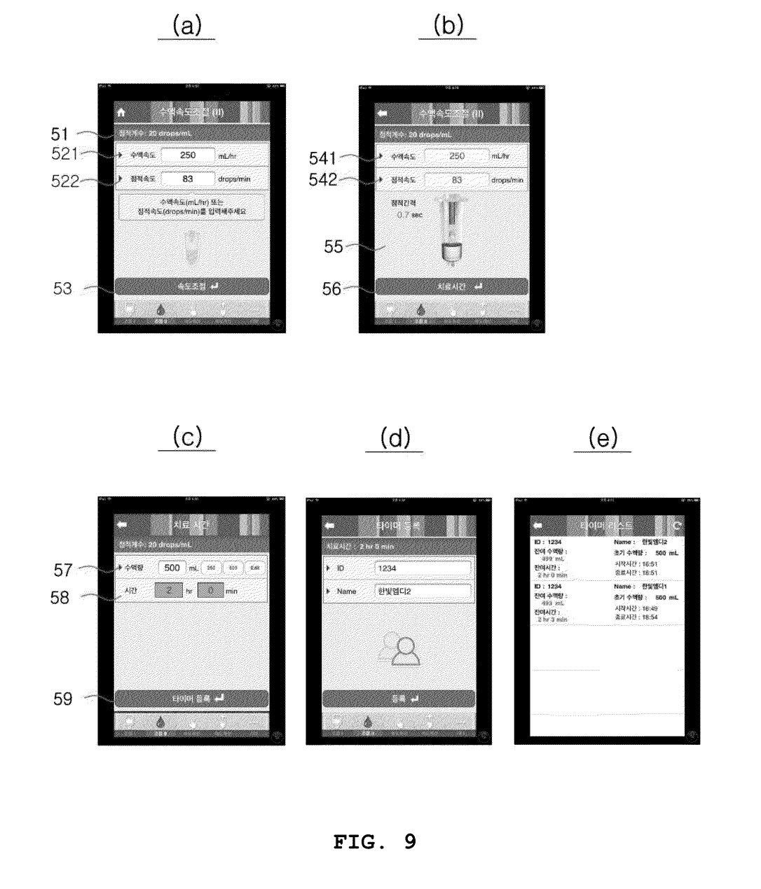

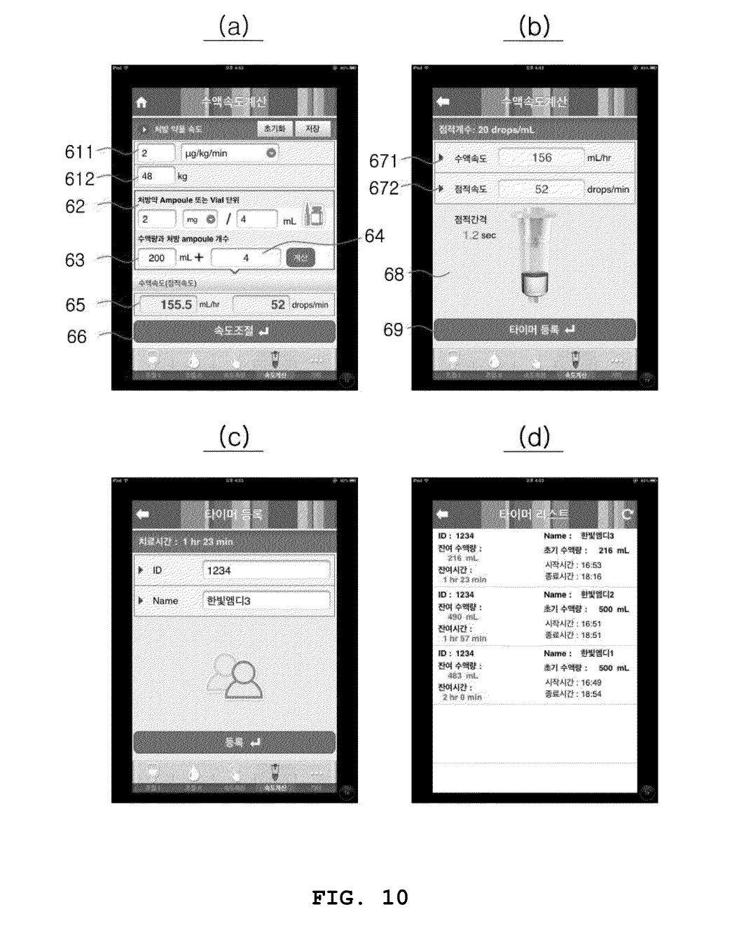

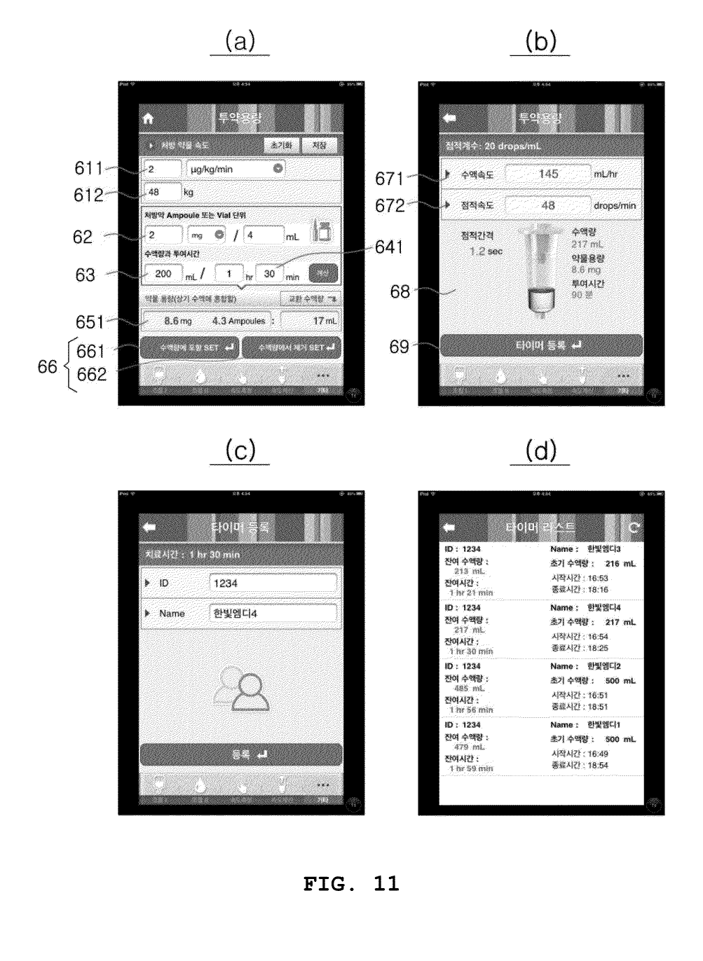

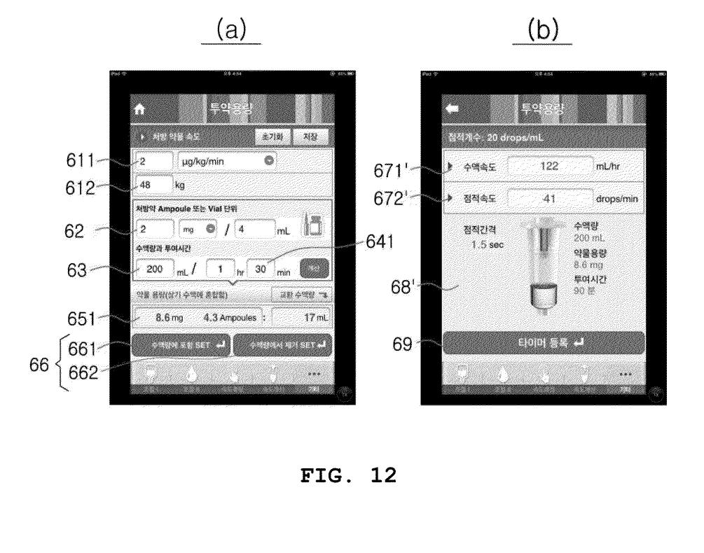

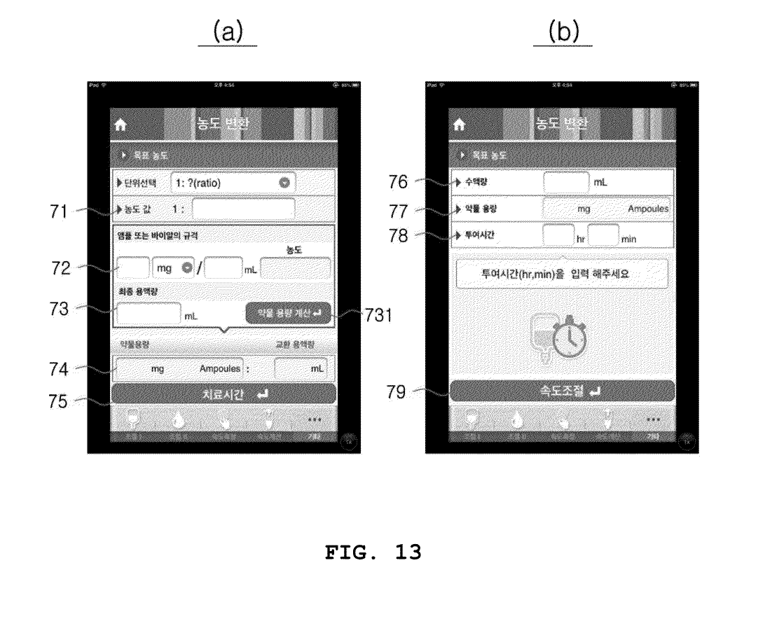

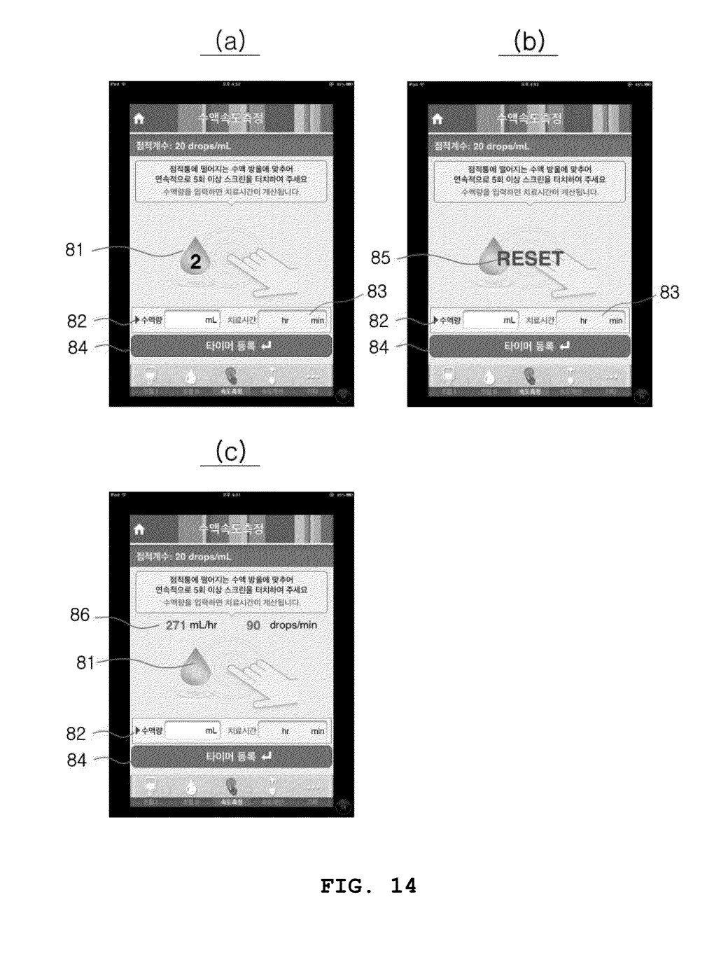

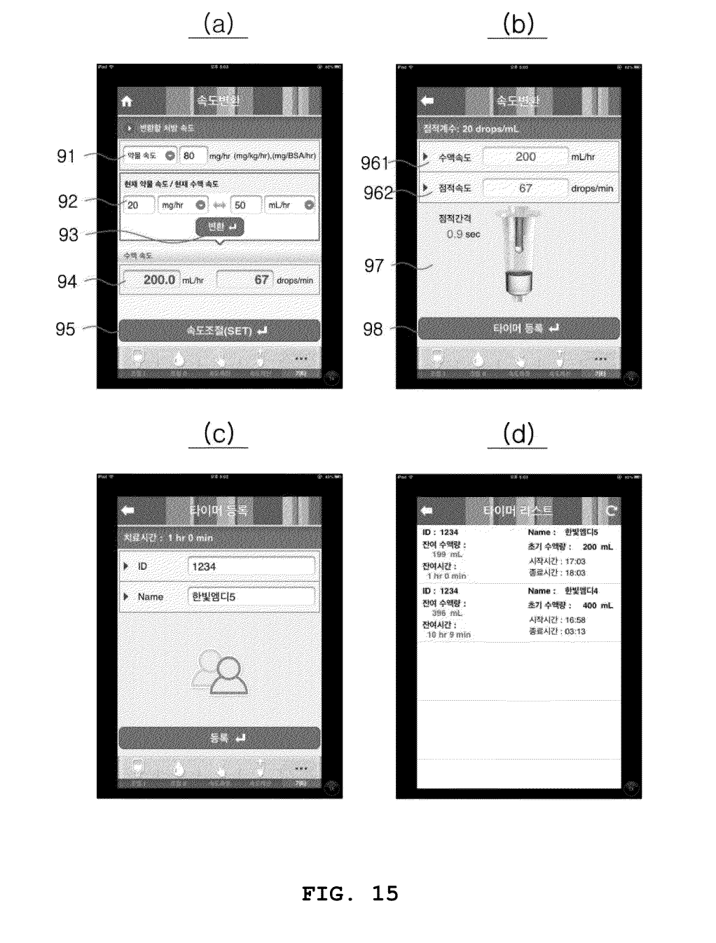

### FIELD OF THE INVENTION

The present invention relates to method for infusion therapy management and recording medium which records the method in mobile device readable application, which controls fluid flow rate of the fluid set with acoustic output on a cycle of dropping rate corresponding to condition for injection of drug to be mixed in the fluid by inputting the condition as prescription for infusion therapy, registers management items by the patient, manages many patients under infusion therapy using one mobile device with knowledge of the present condition of infusion and infusion ending point, and controls the entire process of fluid infusion by modifying the condition of fluid infusion during the infusion

### DESCRIPTION OF RELATED ART

Drawing 1 is an IV (intravenous injection) system to infuse fluid into patients. The infusion set (10) needs to be connected to the fluid bottle (1) as shown in drawing 1 and flow rate should be controlled at dropping rate determined according to infusion prescription. The infusion set (10) consists of the drip chamber (11) which has an insertion needle inserted into a stopper sealing the fluid bottle (1) so that the fluid can flow out of the fluid bottle (1) at the top and drops the fluid in the form of drop (2) in the inside, the injection needle (14) which is inserted into a vein, the tube (13) which connects the drip chamber (11) and the injection needle (14) so as to serve as a fluid injection channel, and the flow rate controller (12) which is installed in the middle of the tube (13) to control flow rate.

The infusion set (10) does not measure flow rate using a flow meter to control the flow rate but count the number of falling drops (2) per minute in the drip chamber (11) to calculate flow rate.

The number of falling drops (2) per minute is called dropping rate. The drop (2) falling in the inside of the drip chamber (11) drops in the form of water drop and is produced so as to have a certain amount. For example, in case of 20 drops per 1 mL of fluid, the amount of one drop is 1/20 mL; in case of 60 drops per 1 mL, the amount of one drop is 1/60 mL. Therefore, if a cycle of falling drop in the inside of the drip chamber (11) is measured, the flow rate of fluid injected through the infusion set (10) can be calculated. Accordingly, fluid flow rate can be calculated applying fluid measure to dropping rate. Or, on the contrary, dropping rate can be calculated from fluid flow rate.

For the flow rate controller (12), a roller clamp type is shown in drawing 1 but it is just one sample. For example, an IV flow regulator type or a flow rate controller illustrated in Registration Patent No. 10-1058539 of this applicant may be used.

Fluid flow rate should be changed little by little using the fluid rate controller (12). Whenever flow rate is changed, the process to measure dropping rate should be repeated. When dropping rate is set to fluid flow rate according to infusion prescription through this repeated change of flow rate and measuring of dropping rate, stop operating the flow rate controller (12) so that fluid is infused at a dropping rate of this time.

Accordingly, the accuracy of fluid flow rate depends upon the accuracy of dropping rate and the measuring of fluid flow rate depends upon the accuracy in measuring dropping rate, too. The present applicant has shown a mobile device for injecting fluid to set and measure dropping rate accurately in Korea Public Patent No. 10-2011-0078483. The mobile device of said patent can be used in infusion therapy by just setting drop fall intervals with periodic acoustic output at dropping rate corresponding to the fluid flow rate determined according to infusion therapy prescription and counting drops upon measuring fluid flow rate. However, the Korea Public Patent No. 10-2011-0078483 has only the functions of measuring and indicating fluid flow rate and yet could not solve the following problems in management of the entire process of infusion therapy.

Infusion therapy mixes prescribed drug and fluid and injected them to patients. At this time, injection rate of prescribed drug which is injected together with fluid and total input influence the effect of infusion therapy and the input of prescribed drug vs. fluid measure greatly work on the effect of infusion therapy. Therefore, fluid measure, drug injection rate and the input of drug are prescribed and a process to inject the fluid mixed with drug is accompanied, but the Korea Public Patent No. 10-2011-0078483 could not carry out such a process.

Moreover, because drug is manufactured in fluid of a certain concentration and a certain amount and sold in ampoules, it should be mixed in fluid considering concentration and amount. For this reason, calculation for manufacturing drug-mixed fluid according to prescription is repeated and verified, and yet, it is still the case that fluid wrongly manufactured due to human error is injected. To reduce such mistakes, sometimes only predetermined several types of fluid is manufactured according to standardized procedure, which lowers the effect of infusion therapy.

Also, because the Korea Public Patent No. 10-2011-0078483 consists of separate dedicated terminal, there are problems of purchase cost, concerns of loss and difficulty in maintenance.

In addition, whether fluid is normally injected or not must be checked even during injection and the condition of injection needs to be changed as occasion demands, and an infusion set should be removed from the patient at the end of fluid injection. However, the Korea Public Patent No. 10-2011-0078483 cannot manage the end of injection in the middle of injection.

### PRECEDING TECHNICAL LITERATURE

### Patent Literature

(Patent Literature 1) KR 10-1058539 B1 2011.08.16
(Patent Literature 2) KR 10-2011-0078483 A 2011.07.07

### DESCRIPTION OF THE INVENTION

### Task to be Solved

Therefore, the purpose of the present invention is to provide method for infusion therapy management which prevent medical accident due to miscalculation or error by controlling fluid flow rate according to prescription of drug that influences the effect of infusion therapy and provide a thorough management of the change of infusion condition, the process of fluid infusion and the ending point of fluid infusion and recording medium which records the method in mobile device readable application.

### Means to Solve the Task

In order to bring about said purpose, for method for infusion therapy management consisting of a mobile device equipped with a touch screen for input/output of information and a timer which provides time information, the present invention consists of a fluid setting step which receives drop coefficients and set them (S1), a setting condition selection step (S2) which calculates the conditions for fluid infusion including fluid flow rate and dropping rate with prescription of fluid measure and the infusion condition of drug to be mixed in the fluid, a therapy setting step (S3) which sets drop intervals of the infusion set according to acoustic cycle with periodical acoustic output on a cycle of dropping rate, and a therapy management step (S4) which registers and saves management items including fluid measure, start time which has the ending point of said therapy setting step (S3), the expected ending point of fluid infusion, the remaining time to the expected ending point and the residual amount of fluid while updating the residual time and the residual amount of fluid as passage of time checked by time information of the timer and alarms upon the expected ending point. In addition, the present invention is embodied in recording medium which records method for infusion therapy management as application executable in mobile device.

### Effect of the Invention

The present invention embodied as abovementioned allows to carry out infusion therapy with prescribed drug rate or fluid concentration as prescription items and to control fluid flow rate by simply obtaining dropping rate without separate calculation process, only with prescriptions.

Also, the present invention enables to see the present status of fluid infusion by the patient at a glance because it registers and saves the management items by the patient and informs of the ending point of fluid infusion so as to conveniently manage infusion therapy without accident.

In addition, the present invention measures fluid flow rate during infusion of fluid and if anything wrong, corrects the applicable management item so as to easily manage many patients.

Besides, the present invention provides an application to be installed in mobile device so that those who have mobile devices can install the application and use the method for infusion therapy management of the present invention and is available at low costs.

### BRIEF DESCRIPTION OF THE SEVERAL VIEW OF THE DRAWING

Drawing 1 is a conventional IV system configuration diagram.

Drawing 2 is a block diagram of mobile device in which an application is installed to embody the method for infusion therapy management according to an embodiment of the present invention.

Drawing 3 is a use example of mobile device in which an application is installed to embody the method for infusion therapy management according to an embodiment of the present invention.

Drawings 4 and 5 are flow charts of the method for infusion therapy according to an embodiment of the present invention.

Drawing 6 is an initial screen for executing application.

Drawing 7 is a setting screen after selecting the Set menu (29) on an initial screen for executing application.

Drawing 8 is a screen after selecting the first rate control menu (21) on an initial screen for executing application, which consists of a screen of the setting condition selection step (S2) (Drawing 8(a)), a screen of the therapy setting step (S3) (Drawing 8(b)), and a screen of the therapy management step (S4) (Drawings 8(c) and 8(d)).

Drawing 9 is a screen after selecting the second rate control menu (22) on an initial screen for executing application, which consists of a screen of the setting condition selection step (S2) (Drawings 9(a)) and 9(c)), a screen of the therapy setting step (S3) (Drawing 9(b)), and a screen of the therapy management step (S4) (Drawings 9(d) and 9(e)).

Drawing 10 is a screen of the setting condition selection step (S2) after selecting the drug rate control menu (24) on an initial screen for executing application.

Drawings 11 and 12 are screens after selecting the dose control menu (25) on an initial screen for executing application.

Drawing 13 is a screen of the setting condition selection step (S2) after selecting the concentration control menu (27) on an initial screen for executing application, which consists of a screen to calculate dose (Drawing 13(a)) and a screen to enter infusion time (Drawing 13(b)).

Drawing 14 is a screen of the therapy management step (S4) after selecting the Measure Rate menu (23) on an initial screen for executing application, which consists of a screen to enterfluid measure (Drawing 14(a)), a screen to indicate wrong count of drops (Drawing 14(b)), and a screen to indicate normal count of drops (Drawing 14(c)).

Drawing 15 is a screen appearing after selecting the Change Rate menu (26) on an initial screen for executing application.

### DETAILED DESCRIPTION TO EMBODY THE INVENTION

The following is description of the present invention referring to drawings with attachment of desirable embodiments so that those who have common knowledge in the relevant field can embody the present invention easily.

First of all, definitions of the terms used in the present invention are as follows:

Fluid measure means a total amount of fluid to be infused into the patient. When it is necessary to separate fluid into one before mixing with drug from one after mixing with drug, fluid mixing with drug is described as a mixed fluid. Fluid measure is used to indicate the amount of fluid before mixing with drug and that of fluid after mixing with drug, and if it is necessary to separate them, description of a mixed fluid is added.

Dose means a total amount of the drug to be mixed in fluid to be infused and applies to a total amount of the drug to be infused to the patient. Because drugs are mixed in diluted solution and sold in a unit of ampoule, dose used in the drawings attached in description of the embodiment of the present invention indicates the amount of pure drugs in mg and the amount of solution mixing pure drugs and diluted solution in ml. The tem of dose indicates the amount of pure drugs for the following prescribed drug rate and the amount of diluted solution mixing with pure drugs for the drug to be mixed in fluid.

Infusion time means the time period which fluid is infused to the patient for infusion therapy.

Fluid flow rate means the flow rate of the fluid infused and is indicated in a dose of fluid per unit time. In case of fluid mixed with drugs, it means the flow rate of the mixed fluid.

Drug rate means the infused amount of prescribed drugs per unit time upon infusion of drugs mixed in fluid. Drug rate obtained by multiplying the following prescribed drug rate by physical condition is the infusion rate of pure drugs.

Prescribed drug rate is a term used to prescribe actual infusion therapy and means drug rate per unit physical condition without considering physical condition (infusion rate of pure drugs). For example, in case of setting weight as physical condition, prescribed drug rate is indicated in the unit of [μg/Kg/min], the rate of drug infused per 1 kg of weight with unit physical condition of 1 kg of weight. And, drug rate is determined by applying physical condition to prescribed drug rate. In the technical field of the present invention, it is obvious that other items than weight can be selected as physical condition.

Dropping rate means the number of fluid drops falling in the form of drop per unit time in the drip chamber of the infusion set. Generally, it is indicated in the unit of [drops/min] which means the number of drops per one minute.

Drop interval means a time gap between drops falling in the drip chamber. That is, one drop falls at a drop interval.

Drop coefficient means the number of drops per unit amount of fluid and is indicated in the unit of [drops/mL]. That is, drop coefficient is a value indicating which number of drops of 1 mL of fluid fall in the drip chamber. It is varied depending upon the specifications of the drip chamber and even with the same specifications, changes a little depending upon the viscosity of fluid, which is ignored in general infusion therapy. It is obvious that the volume of drop can be determined using drop coefficient and it is obvious, too, that fluid flow rate can be determined using the volume of drop and drop interval.

Ampoule standard means the standard of the ampoule containing drug. It includes the amount of pure drug included in the fluid in the ampoule and the amount of the fluid mixing pure drug and diluted solution in the ampoule. Diluted solution is a solution which dissolves pure drug to dilute it to titer. Ampoule standard may include concentration.

Prescription for infusion therapy means matters prescribed by doctor for infusion therapy and includes at least one of the following items: fluid measure, fluid flow rate, dropping rate, infusion time, drug rate, target concentration, prescribed drug rate and physical condition. If drop coefficient is included in prescription for infusion therapy, an embodiment of the present invention should set drop coefficient.

Management item means an item to be managed during infusion therapy and includes fluid flow rate, initial amount of fluid, starting time, expected ending point, residual amount of fluid and residual time.

In the description of embodiments of the present invention, it should be reminded that omitted is the description of such conversion formulae and calculation formulae used in the related art of the present invention as calculation of dropping rate using drop coefficient (or drop volume) when drop coefficient is determined, conversion between dropping rate and fluid flow rate when drop coefficient is determined, calculation of fluid flow rate when fluid measure and infusion time are determined, conversion between drug rate and fluid flow rate when the amount of drug to be mixed and fluid are fixed, and calculation of infusion time when fluid measure and fluid flow rate are determined.

Drawing 2 is a block diagram of mobile device in which application to embody the method for infusion therapy management according to an embodiment of the present invention is installed and drawing 3 is an example of using mobile device.

The method for infusion therapy management according to an embodiment of the present invention is recorded in application which is installed and executed in a mobile device shown in drawing 2. When it is saved in a mobile device and run by user, space to run program is secured in the operating system of the mobile device so as to embody the method for infusion therapy management.

Referring to drawing 2, a mobile device with said application installed can be a smart phone which consists of the communication part (120) for wireless communication, the touch screen (130), the storage part (140) which stores various information and data including application, the timer (150) which provides time information, the application executing part (160) which executes said application and the control part (110) which controls so as to run said application.

For example, said application is received from the server which provides said application through communication network to the communication part (120) and saved in the storage part (140), or downloaded to personal computer and transmitted to the interface (not shown) of mobile device and saved. And, when user selects said application on the touch screen (130) and runs it, the control part (110) reads said application saved in the storage part (140) and controls it so that said application executing part (160) executes it. At this time, the control part (110) controls input/output with the touch screen (130) according to the execution of said application and transfer of time information by the timer (150).

Said application run in said application executing part (160) consists of the event processing processor (161), the rate selecting processor (162), the therapy setting processor (163) and the therapy management processor (164). Said event processing processor (161) executes said application and outputs an initial screen including the menus shown in the following drawing 6 and executes the operation mode corresponding to the menu selected by user in the rate selecting processor (162), the therapy setting processor (163) or the therapy management processor (164). An initial value to run the operation mode is necessary, which is set to a predetermined value or can be changed by user in the setting menu screen shown in the following drawing 7.

Said rate selecting processor (162) takes charge of the execution of the setting condition selection step (S2) according to the prescriptions for infusion therapy and selects dropping rate suitable for the infusion therapy prescription condition.

Said therapy setting processor (163) takes charge of the execution of the therapy setting step (S3) with acoustic output on the cycle of dropping rate and enables users to control a flow rate controller so that drops would fall on the cycle of acoustic output. Said therapy management processor (164) takes charge of the execution of the therapy management step (S4) which manages fluid infusion process and ending point, informs of the ending point of infusion time, and enables user to check fluid flow rate or change fluid infusion condition during fluid infusion.

A mobile device with application installed to embody the method for infusion therapy management according to an embodiment of the present invention is used to infuse fluid according to prescriptions for infusion therapy and manage fluid infusion process and ending time by executing the application when providing infusion therapy to the patient by connecting the fluid bottle (10) and the infusion set (10), as shown in drawing 3.

In order to facilitate understanding for the method for infusion therapy management of the present invention, a brief description of the infusion set (10) is followed.

In the infusion set (10), the drip chamber (11) is fixed at one end of the tube (13) serving as an fluid injection channel and the injection needle (14) is fixed at the other endand the fluid flow rate controller (12) is installed in the middle of the tube (13). When the drip chamber (11) is connected to the fluid bottle (1), fluid falls in the drip chamber (11) in the form of drop (2) and passes through the tube (13) and is infused to the patient at the injection needle (14). When fluid flow rate is changed using the fluid flow rate controller (12), fluid drops fall at an interval of the changed fluid flow rate and fluid flow rate can be determined by measuring dropping rate. In order to adjust fluid flow to fluid flow rate according to prescription of infusion therapy, adjust the fluid flow rate controller (12) so that drops may fall at a dropping rate by converting fluid flow rate to dropping rate.

From now on, the method for infusion therapy management according to an embodiment of the present invention using the mobile device is explained referring to said drawings 2 and 3.

Drawings 4 and 5 are flow charts of the method for infusion therapy management according to an embodiment of the present invention. And drawings 6 through 15 are screens to record the method for infusion therapy management as mobile device readable application and install and execute the application in mobile device.

The method for infusion therapy management according to an embodiment of the present invention is embodied by selecting menus on the initial screen of drawing 6 appearing on the touch screen (130) by executing said application installed in mobile device.

Said menus include the first rate control menu (21), the second rate control menu (22), the Measure Rate menu (23), the drug rate control menu (24), the dose control menu (25), the Change Rate men (26), the concentration control menu (27), the Manage Patient menu (28) and the Set menu (29).

And when user selects a menu according to the procedure of infusion therapy and carry out action corresponding to each menu, the fluid setting step (S1), the setting condition selection step (S2), the therapy setting step (S3) and the therapy management step (S4) of the method for infusion therapy management according to an embodiment of the present invention.

Said setting step (S1) is a step to set default value necessary for the process to determine dropping rate at the following setting condition selection step (S2). Default value is set on the setting screen of drawing 7 appearing after selecting the Set menu (29). Said setting step (S1) includes setting of drop coefficient (31), setting of fluid measure (32) and setting of alarm (33, 34). At this time, for drop coefficient and fluid measure, default values which are usually used are indicated and user can register any value, so one of them can be set. For convenience’ sake, drop coefficient should be set to the value appropriate for the standard of the drip chamber (11) and if it is not selected on the setting screen of drawing 7, it is programmed to set to 20 [drops/min], a value commonly used. The setting of alarm (33, 34) is to set the mode of alarm used in the following therapy management step (s4) with setting of volume and vibration.

Said setting condition selection step (S2) is carried out by selecting one of the first rate control menu (21), the second rate control menu (22), the drug rate control menu (24), the dose control menu (25) and the concentration control menu (27). When an event occurs by selecting a menu (S21), a screen corresponding to the event appears to enter prescriptions for infusion therapy selected by the event and calculate management items according to the prescriptions.

It is classified into the first setting condition selection step upon selecting the first rate control menu (21), the second setting condition selection step upon selecting the second rate control menu (22), the third setting condition selection step upon selecting either the drug rate control menu (24) and the dose control menu (25), and the fourth setting condition selection step upon selecting the concentration control menu (27).

The first setting condition selection step is an action with fluid measure and infusion time as prescriptions for infusion therapy and consists of a step to enter fluid measure/infusion time (S221) and a step to calculate fluid flow rate/dropping rate (S222). At this time, fluid measure means either the amount of the mixture of drug and fluid when drug is mixed in fluid or fluid measure when fluid only is infused. That is, fluid measure means a total amount of fluid infused to the patient. It is obvious in the related art of the present invention that fluid flow rate can be calculated as flow rate during infusion of fluid and dropping rate can be determined by multiplying fluid flow rate by drop coefficient, so detailed account is omitted.

That is, when the first rate control menu (21) is selected, drop coefficient (41) set in the setting step (S1) is indicated, while appearing the screen of drawing 8(a) on which the input field for fluid measure (421) and the input field for infusion time (422) are shown. When a user enters fluid measure and infusion time and selects the rate selector key (43), the screen of drawing 8(b) appears on which fluid flow rate and dropping rate can be determined from fluid measure and infusion time and the following therapy setting step (S3) is followed. The second setting condition selection step has either dropping rate or fluid flow rate and fluid measure as prescriptions for infusion therapy and consists of a step to enter dropping rate or fluid flow rate (S231, S241), a step to determine value not input as the input for dropping rate or fluid flow rate (S232, S242), a step to enterfluid measure (S233) and a step to determine infusion time for fluid measure and fluid flow rate (S234). At this time, fluid measure is a total amount of fluid infused to the patient, as same as the first setting condition selection step.

That is, when the second rate control menu (22) is selected, the drop coefficient (S1) appears while a screen of drawing 9(a) appears on which the input field for fluid flow rate (521) and the input field for dropping rate are shown. When the fluid flow rate is entered, the corresponding dropping rate is calculated and appears on the input field for dropping rate (522) and when dropping rate is entered, the corresponding fluid flow rate is calculated and appears on the input field for fluid flow rate (521). Then, select the rate control key (53) to go to the following therapy setting step (S3). Next, make a screen to enter fluid measure appear as the screen of drawing 9(c) and calculate infusion time. At this time, the screen of drawing 9(c) is set to appear after the following therapy setting step (S3) but this is just for user convenience. Fluid measure may be entered on the screen of drawing 9(a).

Like this, in the first and the second setting condition selection steps, fluid measure, infusion time, fluid flow rate as well as dropping rate can be determined and the variations of residual fluid measure according to passage of time using the timer (150) can be determined, too.

In the third setting condition selection step, prescribed drug rate, physical condition, ampoule standard and fluid measure are included in basic prescriptions for infusion therapy and the number of ampoules or infusion time are also included in the prescriptions to select the setting condition for infusion therapy.

Accordingly, the third setting condition selection step calculates infusion condition for fluid by entering the infusion condition of not fluid but drug to be mixed and infused. To expand this, while the first and the second setting condition selection step calculates dropping rate (or fluid flow rate) using fluid measure and infusion time of the fluid mixing drug or directly enters dropping rate (or fluid flow rate) and deals with infusion condition of fluid mixed with drug, the third setting condition selection step enters infusion condition of drug to be mixed in fluid as prescription for infusion therapy and calculates infusion condition of fluid including drug, for infusion condition of drug included in fluid influences the effect of infusion therapy, rather than that of fluid.

For this, said third setting condition selection step consists of a step to enter prescribed drug rate (S251), a step to enter physical condition (S252), a step to enter ampoule standard (S253) and a step to enter fluid measure (S254) and is divided into a case to enter the number of ampoules and a case to enter infusion time.

For a case to enter the number of ampoules (S2551), multiply the capacity of ampoule standard and the amount of pure drug by the number of ampoules to calculate dose (including the amount of pure drug and diluted solution), multiply prescribed drug rate by physical condition to calculate drug rate, calculate infusion time necessary to infuse a dose of drug at a drug rate, and calculate fluid flow rate and dropping rate to infuse the fluid measure of fluid mixed with dose of drug for infusion time (S252).

Here, it is obvious that drug rate used in this step is calculated by multiplying prescribed drug rate and physical condition, therefore it means infusion rate of pure drug, dose used in calculating infusion time is the amount of pure drug, and dose used in calculating fluid flow rate and dropping rate is the amount of fluid mixing diluted solution and pure drug, and the rest can be understood as above.

Drawing 10 is a screen appearing when the drug rate control menu (23) is selected. Drawing 10(a) is a screen which describes the third setting condition selection step when the number of ampoules are included in prescriptions for infusion therapy and appears on the touch screen (130) when the drug rate control menu (23) is selected. Referring to said drawing 10(a), there are the input fields for prescribed drug rate (611), for physical condition (612), for ampoule standard (62), for fluid measure (63), and for the number of ampoules (64). When the value is entered in each of the fields, fluid flow rate and dropping rate come out (66) and when the rate control key (66) is selected, the screen of drawing 10(b) appears to progress the following therapy setting step (S3). For management items of drawing 10(d), initial fluid measure is determined by adding dose which is calculated by multiplying the amount entered in the input field for ampoule standard (62) by the number of ampoules entered in the input field for the number of ampoules (64) and fluid measure entered in the input field of fluid measure (63).

For a case where infusion is entered (S2561), carry out a step to calculate dose (S2562) to be infused for infusion time at a drug rate after calculating drug rate by multiplying prescribed drug rate by physical condition and a step to calculate fluid flow rate and dropping rate (S2563, S2564, S2565). At this time, a step to calculate rate (S2563, S2564, S2565) is divided into a case where fluid measure entered in said step to enter fluid measure (S254) is the amount of fluid mixed with drug and a case where it is the amount of fluid only and either case should be selected (S2563). In the former, the amount of fluid only can be determined by subtracting dose from the entered fluid measure; in the latter, the amount of mixed fluid can be determined by adding the entered fluid measure and dose (S2564). And fluid flow rate and dropping rate are determined to infuse mixed fluid for infusion time.

Drawing 11 is a screen appearing on the touch screen (130) when the dose control menu (25). Drawing 11(a) is a screen to explain the third setting condition selection step when infusion time is included in prescriptions of infusion therapy. Referring to said drawing 11(a), it is same as drawing 10(a) to include the input fields for prescribed drug rate (611), for physical condition (612), for ampoule standard (62) and for fluid measure (63), but the input field for infusion time (641) is created instead of that for the number of ampoule and if the value is entered in each of the fields, the field to calculate and indicate dose (651) is created.

Enter prescribed drug rate, physical condition, ampoule standard, fluid measure and infusion time to calculate drug rate and calculate a total dose to be infused during infusion time while maintaining drug rate.

The dose calculated at this time includes the amount of drug of ampoule standard in concentration, that is the amount of fluid mixing pure drug and diluted solution, the amount of pure drug and the number of ampoule. Generally, because prescribed drug rate indicates infusion rate of pure drug, dose should be determined by applying the concentration of ampoule standard. A calculus applying the concentration of ampoule standard is obvious in the related art of the present invention and detailed description is omitted.

And, the rate control key (66) is separated into the first key (661) which is pressed when fluid measure entered in the input field for fluid measure (63) is set to the amount of fluid before mixing with drug and the second key (662) which is pressed when fluid measure entered in the input field of fluid measure (63) is set to the amount of mixed fluid. The following therapy setting step (S3) begins by pressing any key or the rate control key (66) separated like this. At this time, the calculation value of fluid flow rate and dropping rate can be different depending upon a key pressed.

Drawings 11(b), 11(c) and 11(d) are screens appearing when the first key (661) is pressed. A screen appearing when the second key (662) is pressed is shown in drawing 12 and described in the following therapy setting step (S3).

When the first key (661) is pressed, as fluid measure entered in the input field for fluid measure (63) is the amount of fluid before mixing with drug, calculate the amount of mixed fluid by adding the fluid measure entered in the input field for fluid measure (63) and calculate dose and fluid flow rate and dropping rate to infuse the amount of mixed fluid during infusion time entered in the input field for infusion time (641).

When the second key (662) is pressed, as fluid measure entered in the input field for fluid measure (63) is the amount of fluid after mixing with drug, calculate dose and fluid flow rate and dropping rate to infuse the amount of mixed fluid during infusion time entered in the input field for infusion time (641). The amount of fluid before mixing with drug is determined by subtracting dose (the amount of fluid mixing pure drug in mg and diluted solution) from the fluid measure entered in the input field for fluid measure (63).

The fourth setting condition selection step has prescriptions including target concentration of mixed fluid with drug, ampoule standard including pure drug and dose contained in standardized ampoule, the amount of mixed fluid and infusion time.

The fourth setting condition selection step consists of a step to enter target concentration of mixed fluid with drug (S261), a step to enter ampoule standard for the drug contained in ampoule (S262), a step to enter fluid measure, target volume of mixed fluid (S263), a step to calculate and show dose so as to make the fluid of target concentration (S264), a step to enter infusion time (S265), and a step to calculate fluid flow rate and dropping rate to infuse mixed fluid during infusion time (S266). At this time, calculate dose and the number of ampoules necessary for filling dose.

Drawing 13 shows a screen appearing when the concentration control menu (27) is selected for the fourth setting condition selection step. On the screen of drawing 13(a), the input fields for target concentration (71), for the amount of pure drug and ampoule standard including the amount of diluted drug contained in ampoule (72), and for the amount of mixed fluid are created to enter applicable values. Then press the dose calculation key (731) to calculate dose and appear it in the field of dose (74). At this time, in the field of dose, the amount of pure drug included in mixed fluid in the unit of mg and the number of ampoules appear. Then, press the therapy time selection key (75) to go to the screen of drawing 13(b) on which the output fields for fluid measure and dose (76, 77) and the input field for infusion time (78) appear. At this time, enter infusion time and press the rate control key (79) to calculate fluid flow rate and dropping rate and carry out the following therapy setting step (S3).

Said setting condition selection step (S2) receives or creates information of fluid flow rate, dropping rate, infusion time and fluid measure whichever of the first, the second, the third or the fourth setting condition selection step is carried out and delivers it to the following therapy setting step (S3). The third and the fourth setting condition selection steps can also determine dose and delivers it to the therapy setting step (S3) to be displayed on the screen. Also, drug rate can be determined and delivered to the therapy setting step (S3) to be displayed on the screen.

Said therapy setting step (S3) is carried out by the therapy setting processor (163) and display the information delivered from said setting condition selection step on the screen with acoustic output on the cycle of dropping rate.

Referring drawings 8(b), 9(b), 10(b), 11(b) and 12(b), a screen is shown when the rate control key (43, 53, 66) is selected on the screen of the setting condition selection step (S2). The output field for fluid flow rate (441, 541, 671, 671′) and for dropping rate ((442, 542, 672, 672′) are created to indicate fluid flow rate and dropping rate and dropping interval (drop falling time interval) in second so as to easily recognize dropping rate is also displayed and the image of drip chamber (45, 55, 68, 68′) of drop falling every dropping interval is also displayed with sound. The registration key (45, 59, 69) is also displayed to carry out the following therapy management step (S4) when the key is selected. Drawing 9, a screen appearing when the second rate control menu (22) is selected, creates the therapy time selection key (56) is created at the bottom of the drawing 9(b), a screen of the therapy setting step (S3), for user convenience so that when the therapy time selection key (56) is pressed, the screen of drawing 9(c) appears on which the display field for fluid flow rate (571), the display field for infusion time (58), the input field for fluid measure (572) and the registration key (59) are shown. At this time, when fluid measure is entered, infusion time is calculated and displayed and when the registration key (59) is pressed, the following therapy management step (S4) is carried out. It is possible because fluid measure and infusion time may be entered after the therapy setting step (S3) upon selection of the second rate control menu (22).

Drawings 10(b), 11(b) and 12(b) which show the therapy setting step (S3) carried out after the third setting condition selection step are similar to drawings 8(b) and 9(c) of the therapy setting step carried out after the first and the second setting condition selection steps, provided that in this case, infusion condition of fluid is obtained from that of drug and the values of fluid flow rate and dropping rate are different from each other.

To expand this, referring to drawing 10, a screen appearing when the drug rate control menu (24) is selected, fluid flow rate and dropping rate are calculated and displayed based on mixed fluid of which amount is the sum of the entered fluid measure and the calculated dose. This can be known from that the sum of fluid measure and dose is displayed as initial fluid measure on the screen of drawing 10(d) for the following therapy management step (S4).

In addition, on the screen of drawings 11(b) and 12(b) which display the therapy setting step (S3), the amount of mixed fluid, dose and infusion time are displayed. However, because drawing 11(b) is a screen appearing when the dose control menu (25) is selected but displays the amount of mixed fluid which add the entered fluid measure and dose and drawing 12(b) displays the amount of mixed fluid, even if same infusion condition is entered as prescription for infusion therapy, the amount of mixed fluid displayed on drawings 11(b) and 12(b) is different. And fluid flow rate (or dropping rate) and dropping interval are different, too.

For drawing 13, a screen appearing when the concentration control menu (27) is selected, although the screens for the therapy setting step (53) and the therapy management step (S4) are not displayed, a screen for the drug rate control menu (24) or the dose control menu (25) may be used.

Like this, with periodic acoustic output according to dropping rate in the therapy setting step (S3), a user may manipulate the fluid flow rate controller (12) so as to make the fall cycle of drops falling in the drip chamber (11) of the infusion set (10) matched to acoustic cycle and control fluid flow rate of the infusion set (10).

Said therapy management step (S4) is carried out by the therapy management processor (164) after the fluid flow rate of the infusion set (10) is set to dropping rate, and consists of a set to register and save management items (S41), a step to check passage of time after registration and saving (S42) and sound alarm when infusion time is arrived (S43), a step to update management items according to passage of time if infusion time is not arrived (S44), and a step to check whether management event occurs or not (S46) and if it occurs, process the management event.

Said management items are items to be monitored and managed during infusion of fluid after setting fluid flow rate of the infusion set and include fluid flow rate, drug rate, initial fluid measure, start time of infusion, expected end time after a lapse of infusion time, residual time from the present point to expected end time and residual fluid measure which indicates variations of residual fluid measure as time passes.

Referring drawings 8(c,d), 9(d,e), 10(c,d), and 11(c, d), when the registration key (48, 59, 69) is pressed on a screen of the therapy setting step (S3), a screen to enter ID and name to be given to the patient appears. At this time, enter and register ID and name to go to a screen for at least one of the management items. Not all items included in management items are required to be displayed. For example, as shown in the drawing, initial fluid measure, start time of infusion, expected end time which indicates the time after a lapse of infusion time, residual time which varies as time passes, and residual fluid measure are displayed. The screen of drawings 8(d), 9(e), 10(d) and 11(d) which display the list of management items by the patient can be seen by selecting the patient management menu (28) on the initial screen of drawing 6. Although drawing 12 does not show the registration screen of management items, it works in the same form.

Among management items, start time can be set as the time to press said registration key (48, 59, 69). Said start time may be set as the time to enter ID and name, but for the sake of accuracy, it is desirable to set to the time to press said registration key (48, 59, 69) appeared on the touch screen so as to set the ending time of said therapy setting step (S3) as start time.

And, residual time until expected ending time is calculated by getting time information from the timer (150) and residual fluid measure is calculated by subtracting the amount of infused fluid as time passes from fluid measure and residual time and residual fluid measure are updated. Accordingly, when residual time becomes 0, the alarm step (S43) is carried out. The update status of management item can be seen from the patient management menu (28), even before sounding alarm.

Management event is an event to measure and change rate. When the rate change menu (26) is selected on the initial screen of drawing 6, rate change menu (26) is carried out and when the rate measure menu (23) is selected, rate measure event is carried out.

When this kind of management event occurs, select the ID of the patient already registered and saved so as to change management item of the patient. That is, when management event occurs, the patient management menu (28) is automatically carried out to select the applicable patient (that is, an ID used to save the management item) and the management item registered and saved for the patient is handed over to carry out the event processing process. As a different way, for management event, press the patient management menu (28) on the initial menu screen and select one of the registered patients by the ID so that a screen to select either the rate change menu (26) or the rate measure menu (23) may appear to be selected.

When the rate measure event occurs, a screen of drawing 14 appears to measure fluid flow rate of the infusion set. Then, a step to display a notice to count drops falling in the drip chamber (11) as many as a predetermined number and let a user enter the count of drops (S471), a step to get the mean of drop interval with time difference between count inputs to determine dropping rate and then calculate fluid flow rate using dropping rate and drop coefficient (S452), a step to enter fluid measure (S473), a step to determine infusion time necessary to infuse fluid at an infusion rate (S474), and a step to create management items and register and save them (S41) are carried out.

Like this, as management items created by the rate measure event are registered and saved, if infusion time is not arrived after sounding alarm according to whether the time is arrived or not, management items are updated as time passes. For management items, the existing registered and saved items may be changed or new items can be registered and saved, and for the latter, delete the existing items or leave them as they are and turn off alarm. Drawing 14 is a screen appearing when the rate measure menu (23) is selected and the rate measure event occurs. First, a message to count drops as many as the predetermined number is displayed and the position on the touch screen to touch whenever count drops (81), the input field for fluid measure (82), the display field for infusion time (83) and the registration key (84) are displayed on a screen of drawing 14(a). Accordingly, when a user touch the touch screen, it is recognized that drops should be counted, and when counting is done as many as the predetermined number, the mean of drop interval is calculated based on time difference between count inputs and dropping rate and fluid flow rate are calculated and displayed on a screen of drawing 14(c).

In the input field for fluid measure (82), enter residual fluid measure or display the present residual fluid measure included in management items and calculate time required to infuse the residual fluid measure at a fluid flow rate and display infusion time. Then, press the registration key (84) to register and save infusion time. That is, residual fluid measure is infused at a measured fluid flow rate with the time to measure fluid flow rate as start time. Calculate expected ending time after a lapse of infusion time to change management item.

The description of calculation of fluid flow rate according to the count input of drops is omitted because it is described in detail in Public Patent No. 10-2011-0078483 of the present patentee.

Meanwhile, dropping interval is calculated for every count input when counting drops as many as the predetermined number. And, when the error between the mean of the entered dropping interval and the present dropping interval according to the present input of count is larger than the predetermined error, the application determines that count input is wrong and displays the term of ‘RESET (85)’ as shown in drawing 14(b). Accordingly, the application makes count entered again as many as the predetermined number and induce to accurately enter count. The method for reentering count when there is error in count input interval is described in said public patent No. 10-2011-0078483, and detailed description for the same is omitted.

When the rate change event occurs upon selection of the rate change menu (26), the application carries out a step to receive change rate (S44) and goes to said therapy setting step (S3) and carries out the therapy setting step (S3) then returns to the therapy management step (S4). That is, change rate is the flow rate of the fluid currently infused or the rate to change drug rate. When change rate is entered, said therapy setting step (S3) appears to control fluid flow rate according to the changed rate. Of course, after therapy setting step (S3), said therapy management step (S4) is carried out to register and save.

Drawing 15 shows a screen to process the rate change event appearing when the rate change menu (26) is selected. Referring to drawing 15(a), the input field for changed rate (91), the display field for current rate (92), the change key (93), the display field for changed rate/dropping rate (94), and the rate control key (95) are displayed on the screen.

In the input field for current rate (92), fluid flow rate or drug rate among the management items for the patient who is under infusion of fluid are displayed. And, in the input field for changed rate (91), select either drug rate or fluid flow rate and enter changed rate and press the change key (93) to display the applicable value to the changed rate in the display field for changed rate/dropping rate (94).

In the display field for changed rate/dropping rate (94), fluid flow rate and dropping rate are displayed when drug rate is entered as changed rate and drug rate and dropping rate are displayed when fluid flow rate is entered as changed rate. And when the rate control key (95) is pressed, as shown in drawing 15(b), a screen of the therapy setting step (S3) appears on which the display field for fluid flow rate (961), the display field for dropping rate (962), the image of drop chamber (97) and the registration key (98) appears and at this time, the changed rate (fluid flow rate and dropping rate) is displayed with periodic acoustic output corresponding to the changed rate. When the registration key (93) is pressed, the management item applying the changed rate is registered and saved. In the management items, fluid measure means the current residual amount of fluid, the infusion time means the time required to infuse residual fluid at a changed rate, start time means the current time and expected ending time means the time which adds the current time and infusion time.

As mentioned above, the method for infusion therapy management according to an embodiment of the present invention enables to mix drug and fluid so that infusion condition of mixed fluid to be infused to the patient can be obtained from fluid measure and infusion condition of drug. At this time, infusion condition of mixed fluid consists of the combination of fluid measure and infusion time or that of fluid flow rate (or dropping rate) and fluid measure. Infusion condition of drug is the combination of prescribed drug rate, physical condition, ampoule standard and the number of ampoules, that of prescribed drug rate, physical condition, ampoule standard and infusion time, or that of fluid concentration, ampoule standard and infusion time.

Therefore, in reality that infusion condition of drug which highly influences the effect of infusion therapy is one of the prescriptions of infusion therapy, the present invention can be very useful.

Also, because the present invention sets accurately fluid flow of the infusion set with periodic acoustic output and registers and manages management items by the patient, it can manage the entire process of infusion therapy using one terminal.

The method for infusion therapy management according to an embodiment of the present invention, as discussed referring to drawings 2 and 3, is recorded in application which can be executed in mobile device. Therefore, those who have mobile device can use the method for infusion therapy management according to an embodiment of the present invention by reading the application which can execute the method from a recording medium and installing it in mobile device.

### LEGEND

1: fluid bottle 2: drop
10: infusion set 11: drip chamber 12: fluid flow rate controller
13: tube 14: injection needle
21: the first rate control menu 22: the second rate control menu
23: rate measuring menu 24: drug rate control menu
25: dose control menu 26: rate change menu
27: concentration control menu 28: patient management menu
29: setting menu
100: mobile device 110: control part 120: communication part
130: touch screen 140: storage part 150: timer
160: application execution part
161: even processing processor 162: rate selecting processor
163: therapy setting processor 164: therapy management processor

What is claimed is:

1. Method for infusion therapy management using mobile device equipped with the touch screen to input/output information and the timer to provide time information which consists of
a fluid setting step to receive drop coefficient and set it (S1),
a setting condition selection step (S2) to receive fluid measure and infusion condition of drug to be mixed with fluid and infused to the patient as prescriptions for infusion therapy and determine infusion condition of fluid including fluid flow rate and dropping rate,
a therapy setting step (S3) to output sound on the cycle of dropping rate and set dropping interval of the infusion set according to acoustic cycle, and
a therapy management step (S4) to register and save management items including fluid measure, start time with ending time of said therapy setting step (S3), expected ending time of fluid infusion, residual time to expected ending time and residual fluid measure and update residual time and residual fluid measure based on passage of time read from the timer and alarm upon arrival of expected ending time.

2. The method for infusion therapy management as claim 1, wherein said setting condition selection step (S2) has infusion conditions of drug including prescribed drug rate, a drug rate per unit physical condition, patient's physical condition, dose and the amount of pure drug, ampoule standard and the number of ampoules, determines dose by multiplying ampoule standard by the number of ampoules, determines drug rate by multiplying prescribed drug rate by physical condition, determines infusion time required to infuse dose at a drug rate, and determines fluid flow rate and dropping rate required to infuse the amount adding up fluid measure and dose during infusion time.

3. The method for infusion therapy management as claim 1, wherein said setting condition selection step (S2) has infusion conditions of drug including prescribed drug rate, a drug rate per unit physical condition, patient's physical condition, dose and the amount of pure drug, ampoule standard and infusion time, determines drug rate by multiplying prescribed drug rate by physical condition, determines dose infused at a drug rate during infusion time, and determines fluid flow rate and dropping rate required to infuse the amount adding up fluid measure and dose during infusion time.

4. The method for infusion therapy management as claim 3, wherein said setting condition selection step (S2) allows a user to decide whether the entered fluid measure is the amount of fluid after mixing with drug or before mixing with drug, and when a user sets the entered fluid measure to the amount of fluid mixed with drug, calculates fluid flow rate and dropping rate required to infuse the fluid measure during infusion time.

5. The method for infusion therapy management as claim 1, wherein said setting condition selection step (S2) has infusion conditions of drug including target concentration of fluid mixed with drug, ampoule standard including dose and the amount of pure drug, and infusion time and calculates dose necessary to get the target concentration of the fluid mixed with drug and the number of ampoules of ampoule standard necessary to fill dose.

6. The method for infusion therapy management as claim 1, wherein said therapy management step (S4) includes the rate measure step which selects the registered and saved management items and calculates dropping rate and fluid flow rate at dropping intervals by counting drops falling in the infusion set on the touch screen, calculates infusion time when residual fluid measure is infused at a fluid flow rate and changes management item by setting the time to carry out the rate measure step as start time.

7. The method for infusion therapy management as claim 1, wherein said therapy management step (S4) includes the rate change step which selects the registered and saved management items and changes fluid flow rate and drug rage, returns to said setting condition selection step (S2) to set dropping interval according to the change fluid flow rate and calculates infusion time upon infusion of residual fluid measure at the changed fluid flow rate and changes management items.

8. Recording medium which records the method for infusion therapy management consisting of claim 1 in application which can be executed in mobile device.

9. Recording medium which records the method for infusion therapy management consisting of claim 7 in application which can be executed in mobile device.
